(19) United States
(12) Patent Application Publication
(10) Pub. No.: US 2024/0164419 A1
(43) Pub. Date: May 23, 2024

(54) COCONUT-BASED ESSENCE COMPOSITION AND METHOD FOR PREPARATION THEREOF

(71) Applicant: Jose Rincon, Miami, FL (US)

(72) Inventor: Jose Rincon, Miami, FL (US)

(21) Appl. No.: 18/424,273

(22) Filed: Jan. 26, 2024

Related U.S. Application Data
(63) Continuation-in-part of application No. 16/796,600, filed on Feb. 20, 2020.

(51) Int. Cl. A23L 19/00; A23B 7/04; A23L 7/196; A23L 27/12

(52) U.S. Cl. CPC A23L 19/09; A23B 7/04; A23L 7/1965; A23L 27/12

(57) ABSTRACT

A coconut-based essence composition comprising coconut cream concentrate, testa, sugar and salt is provided. The coconut-based essence composition is prepared by pulverizing coconut meat forming the coconut cream concentrate and the testa of coconut to an average particle size of 0.001 microns, grinding the pulverized coconut meat and testa to obtain a fibrous pulp containing a coconut essence liquid, separating the coconut essence liquid from the fibrous pulp, adding sugar and salt to the coconut essence liquid to obtain a coconut-based essence mixture, blending the coconut-based essence mixture for about 5 to 10 minutes to obtain the coconut-based essence composition, partitioning the coconut-based essence composition into a plurality of vacuum sealable packages and storing under freezing temperature. The coconut-based essence composition is thawed and applied directly to traditionally prepared rice resulting in a replica of authentic Colombian coconut rice.

### CROSS-REFERENCE TO RELATED APPLICATIONS

This application is a continuation-in-part of the U.S. application Ser. No. 16/796,600 filed on Feb. 20, 2020. This continuation-in-part application claims the benefit of the U.S. Provisional Patent Application No. 62/808,016, filed on Feb. 20, 2019, which is incorporated herein in its entirety.

### FIELD OF THE INVENTION

The present invention relates generally to food composition and methods of preparation. More particularly, the present invention relates to a coconut-based essence composition meant to be integrated with rice and methods for preparation.

### BACKGROUND OF THE INVENTION

Over the last decade, nutritionists and health professionals have advocated for coconuts due to many health benefits associated with them such as being great for hair and skin care and being an excellent source of fiber, potassium, vitamin B6, iron, and minerals like magnesium, zinc, copper, manganese, and selenium. Due to these recently discovered benefits, the use of coconuts and coconut-based products has significantly increased in popularity.

Throughout the Caribbean and Latin America, coconuts have historically been considered a versatile, nutritionally dense, and distinctly flavorful superfood. Countries in these regions along with others have utilized coconuts for purposes that range all the way from electrolyte replenishment via coconut water to hair sheen via coconut oil. In particular, coconut rice has traditionally been a popular dish partially due to the fact that oils used to prepare traditional rice are not as financially accessible as coconuts in certain regions.

However, preparation of coconut rice can be a rather difficult task because of the complexity associated with the dish's flavor, texture, and color along with the intricacies associated with shredding and straining contents within the coconuts needed in order to accomplish the authentic flavor, texture, and color. For example, if there is a lack of precision in the preparation of the dish then it can result in the rice being too bland, not having the desired texture, or being burnt. Also, the hazardous process of shredding and straining contents within the coconuts are likely to result in injury, which may contaminate the dish. Due to this dilemma, the commercialization of coconut rice has not been successfully accomplished for it requires a time consuming and arduous set of tasks in order to replicate the characteristics that reflect the authenticity of the traditional dish.

Accordingly, there is an established need for an authentic coconut rice preparation mixture and methods associated with the preparation mixture in order to not only replicate the authentic characteristics of traditional coconut rice, but also avoid the painstaking process of preparing the dish.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF THE INVENTION

The present invention provides a coconut-based essence composition comprising about 140 grams of coconut cream concentrate, about 30 grams of testa, about 35 grams of sugar and about 11 grams of salt. The coconut-based essence composition is prepared by pulverizing coconut meat forming coconut cream concentrate and testa of coconut to an average particle size of 0,001 microns, grinding the pulverized coconut meat and testa to obtain a fibrous pulp containing a coconut essence liquid; separating the coconut essence liquid from the fibrous pulp, adding sugar and salt to the coconut essence liquid to obtain a coconut-based essence mixture, blending the coconut-based essence mixture for about 5 to 10 minutes to obtain the coconut-based essence composition, partitioning the coconut-based essence composition into a plurality of vacuum sealable packages, and storing under a freezing temperature.

In one embodiment, the fibrous pulp is strained to obtain the coconut essence liquid during separation. In one embodiment, the coconut-based essence composition comprises an amalgam comprising the pulverized coconut meat and testa, the coconut-based essence mixture, and residue of the interior and external surface of the coconut. The amalgam comprises at least 1.3 oz of coconut shreds derived from the interior of the coconut. In one embodiment, the method comprises thawing the coconut-based essence composition and whisking for a brief period to generate a creamy or milky texture of the composition. In one embodiment, 750 cc of the coconut-based essence composition is applied to 1 lb of rice. In one embodiment, the coconut-based essence composition is applied to the rice in a ratio of 1:1 for consumption. The provided metrics allow the 1:1 ratio translating to 1 lb of coconut used for the coconut-based essence composition per lib of rice. In one embodiment, the coconut meat and the testa are extracted from the coconut by any one of puncturing, slicing, and splitting the coconut. In one embodiment, the method comprises adding purified water or any other suitable liquid to the pulverized coconut meat and the testa and filtering to obtain the coconut essence liquid.

In an embodiment, the internal components of the coconut are extracted and shredded via a grater mechanism configured to extrude and grate the internal components of the coconut into a plurality of fragments. The grater mechanism may be a sheet of metal or any other element or alloy comprising a plurality of small openings housed between a left-most end and right-most end, which may be made of wood or any other suitable material. The grater mechanism may be configured to shred a coconut in order to extract the coconut meat in a desirable size, strain the coconut in order to extract the coconut essence liquid yielding approximately 750 cc of the coconut essence liquid comprising approximately 1.3 ounces of coconut shreds.

In an embodiment, the coconut may be approximately 16 ounces in weight and the internal components of the coconut may be acquired via chopping, skinning, puncturing, or any other efficient mechanism for obtaining access to internal components of a coconut.

The internal components of the coconut may include but are not limited to, exocarp, mesocarp, endocarp, testa, meat, water, or any other extractable component of a coconut.

In an embodiment, spices, or condiments, but are not limited to table salt, sea salt, sugar, herb, and seasoning may be added to the coconut essence liquid to add flavor or zest to a substance.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIGS. 1A-B are flow diagrams that depict an example process for preparing the coconut-based essence composition, in an embodiment.

Like reference numerals refer to like parts throughout the several views of the drawings.

### DETAILED DESCRIPTION

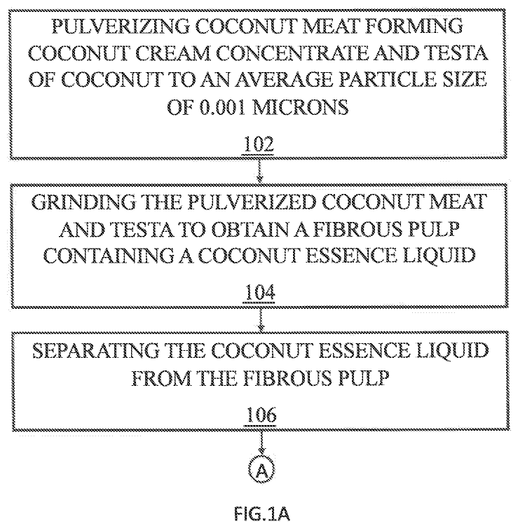

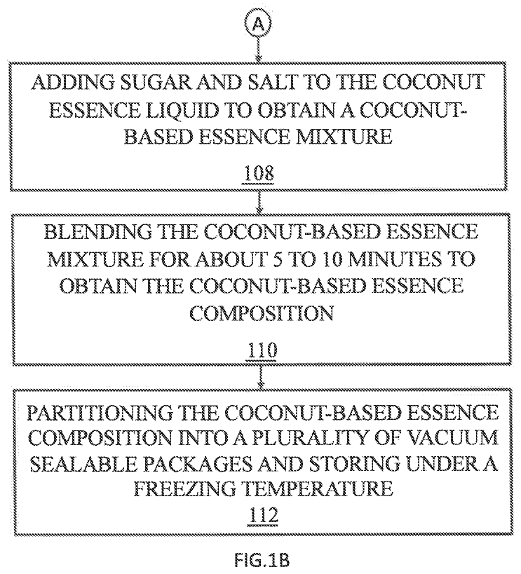

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a coconut-based essence composition and methods associated with preparing the coconut-based essence composition.

FIGS. 1A-B are flow diagrams that depict a process 100 for preparing a coconut-based essence composition, in an exemplary embodiment. At block 102, coconut meat forming coconut cream concentrate and the testa of coconut are pulverized to an average particle size of 0.001 microns. At block 104, the pulverized coconut meat and testa are ground to obtain a fibrous pulp containing a coconut essence liquid. A coconut with an approximate weight of 16 ounces comprising approximately 100 cc of coconut essence liquid. At block 106, the coconut essence liquid is separated from the fibrous pulp. At block 108, sugar and salt are added to the coconut essence liquid to obtain a coconut-based essence mixture. At block 110, the coconut-based essence mixture is blended for about 5 to 10 minutes to obtain the coconut-based essence composition. At block 112, the coconut-based essence composition is partitioned into a plurality of vacuum sealable packages and stored under a freezing temperature. The internal components of a coconut (not shown) are extracted. The internal components of the coconut may be extracted by skinning and puncturing the coconut or slicing or splitting the coconut allowing the internal components of the coconut to be carved out. The extraction of the internal components of the coconut results in the coconut meat and testa in the form of shreds, shards, and pulp that may contain fragments of the interior and/or exterior surface of the coconut.

In one embodiment, the grater mechanism may comprise a panel of metal comprising a plurality of small openings housed between a left-most end and a right-most end configured to be gripped by a user (not shown). The coconut meat and the testa are pulverized and/or grated by the grating mechanism. The grating mechanism is configured to extrude or grate the internal components of the coconut. In one embodiment, the coconut meat and the testa may be pulverized by chopping, dicing, blending, or any other suitable mechanism including but not limited to a knife, blender, chopper, or food processor. In one embodiment, the grated/pulverized coconut meat and the testa are gathered or compiled in a first reservoir (not shown).

In one embodiment, about 600 cc to about 650 cc of purified water or any other suitable liquid is added to the first reservoir comprising the coconut meat and testa and extracted to obtain the coconut essence liquid. In one embodiment, the coconut-based essence composition includes a combination of pulverized coconut meat, testa and fragments of the interior and/or exterior of the coconut.

In one embodiment, the coconut essence liquid is poured onto a straining mechanism positioned above a second reservoir (not shown) allowing the straining mechanism to strain and filter undesired shards and pieces of the internal and/or external surfaces of the coconut and other undesired components within the coconut essence liquid via the plurality of small openings.

In one embodiment, the coconut-based essence composition comprises at least 750 cc of an amalgam comprising the plurality of fragments, the coconut essence liquid, and residue of the interior and external surface of the coconut allowing a desired amount of components of the coconut within the coconut-based essence composition to ensure an authentic coconut flavor. The amalgam comprises at least 1.3 oz of coconut shreds derived from the interior of the coconut.

In one embodiment, about 5.25 to about 5.6 grams of table salt and about 30 to about 32 grams of pure cane sugar are added to the coconut essence liquid and blended to obtain a coconut-based essence mixture to provide a sweet and savory taste to the composition. In one embodiment, one or more other spices or condiments may be added to the coconut essence liquid in order to increase zest, tang, or any other suitable adjustments associated with flavor, color or texture.

In one embodiment, the coconut-based essence mixture is blended into a concentrated mixture. The concentrated mixture captures the authentic flavor of the coconut and is configured to be integrated with rice and other applicable grains in order to provide a coconut zest that resembles authentic Colombian coconut rice.

The coconut-based essence composition is partitioned into a plurality of sealable packages. In one embodiment, the sealable packages may be a pouch, pocket, cavity, or any other enclosable packet suitable for retaining and preserving the coconut-based essence composition. The sealable packages may be plastic or any other material suitable for sustaining storage in freezing temperatures. In one embodiment, the sealable packages may comprise a fastener or sealing mechanism configured to allow reversible fastening and unfastening thereof. In some embodiments, the fastener can be a Ziploc® or other similar resealable zipper- or slider-type fastener. In some embodiments, the sealable packages may be sealed by a male & female interlocking sealing structure or any applicable mechanism comprising sealant characteristics.

In one embodiment, the plurality of sealable packages is configured to retain moisture and flavor of the coconut-based essence composition and sustain the preservation of the coconut-based essence composition via freezing, storing, or any other applicable method for preservation.

For the purpose of illustration, a preserved sealable package comprising the coconut-based essence composition may be available at local supermarkets or grocery stores in the frozen foods department. Due to the necessity of preserving the authentic coconut flavor, the coconut-based essence composition requires that it be stored at a temperature that is suitable for preserving the coconut-based essence composition in a solid frozen state. Upon purchase, the coconut-based essence composition is configured to be thawed or unfrozen on the stovetop, warmed or defrosted in the microwave (timing depending on the wattage of the microwave), or put in a blender to be whisked for a brief period of time in order to generate a creamy or milky texture. In one embodiment, the user may manually whisk the coconut-based essence composition in order to achieve the desired creamy texture. Once this creamy texture is accomplished, the coconut-based essence composition is configured to be added or integrated with a plurality of rice or any other applicable grain by mixing, blending, stirring, or any other applicable method of combining the coconut-based essence composition and the plurality of rice. The coconut-based essence composition is configured to not require any additional water, oil, or any other liquid substance to be added, and the rice or applicable grain may be prepared in any traditional method such as but not limited to rice cooker or stovetop.

Based upon the provided method, a 16 oz coconut used to generate the coconut-based essence composition is configured to yield enough of the coconut-based essence composition to be integrated with at least 1 lb. of traditional white rice. Various amounts of the coconut-based essence composition may be added to varying amounts of traditional white rice or any applicable grain based upon the preferences of the user; however, in order to ensure a finished product of an authentic dish of Colombian coconut rice that comprises the desired taste, texture, and color, the preferred amount of the coconut-based essence composition added to 1 lb. of rice is 750 cc, which is equivalent to 3 cups of the coconut-based essence composition.

In one embodiment, the coconut-based essence composition may be used for an alternative cuisine purpose such as a food marinade, glaze, dressing, relish, condiment, or any other applicable purpose.

The disclosed invention allows the following advantages over the prior art: the coconut-based essence composition and methods for preparing the composition enable consumers to prepare traditional authentic Colombian coconut rice without having to deal with issues typically associated with the preparation of coconut rice. These issues include but are not limited to time and energy associated with slicing coconuts and obtaining the internal components of the coconuts required to make the dish, and dangers associated with grating and shredding the internal components of the coconuts that commonly result in not only injury to the preparer but also contamination of the coconut-based essence composition. The coconut-based essence composition allows for simple integration with traditional white rice and any other applicable grain by unthawing or defrosting the coconut-based essence composition until it establishes a creamy-like texture and stirring the coconut-based essence composition into the rice. This results in a replica dish that resembles the acclaimed flavor, texture, and color of authentic Colombian coconut rice.

In conclusion, the disclosed method produces a freezer-friendly product that has a long shelf life, making it easily accessible to customers and available at any local supermarket. The frozen product may be thawed at room temperature or in the microwave before use. In use, the customer adds a desired amount to any kind of rice. The ratio may be a 2 to 3 ratio of the disclosed product to rice, or vice-versa in some examples. There is no need for water or oil to be added, and the rice can be prepared in a rice cooker or on the stovetop.

The disclosed authentic Colombian coconut rice preparation mix has many advantages and is carefully crafted to succeed where similar products have failed.

First of all, mature coconuts go rancid very quickly. Refrigerating the coconut mix expands its shelf life to one month without compromising any of its flavorful, fresh taste. The product is readily available, stocked in the freezer aisle of a local supermarket, for example.

Also, the packaged product has been specially formulated so that consumers can prepare truly authentic Colombian coconut rice at home, in a fraction of the time that it would normally take. The cooking process is easy and straightforward—anyone, anywhere is capable of making perfect coconut rice with the disclosed recipe and product.

The product is perfect for any variation of coconut rice and will also enhance any recipe that requires coconut or coconut milk.

The disclosed method and formula may produce a product that is simple, all-natural, organic, and high in vital nutrients. Sugar-free and low-sodium versions may be produced accordingly.

It is to be understood that the herein disclosed coconut product may be used with any recipe, food, or dish that requires coconut ingredients such as coconut fish or coconut shrimp.

Furthermore, it is to be understood that the above-described proportions of ingredients may be adjusted. For example, in one example, for every 750 cc of coconut product (i.e. coconut essence liquid), which may be 16 Oz of coconut/100 cc of pure coconut cream concentrate, may have 5.25 to 7.5 grams of salt and 26.25 to 30 grams of sugar. In other words, per every liter of coconut essence liquid (e.g. 1000 cc) there should be 7.0 to 10.0 grams of salt and 35.0 to 40.0 grams of sugar included.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A coconut-based essence composition comprising about 140 grams of coconut cream concentrate, about 30 grams of testa, about 35 grams of sugar and about 11 grams of salt.

2. A method for producing a coconut-based essence composition, wherein the method comprises:
pulverizing coconut meat forming coconut cream concentrate and testa of coconut to an average particle size of 0.001 microns, grinding the pulverized coconut meat and testa to obtain a fibrous pulp containing a coconut essence liquid; separating the coconut essence liquid from the fibrous pulp; adding sugar and salt to the coconut essence liquid to obtain a coconut-based essence mixture; blending the coconut-based essence mixture for about 5 to 10 minutes to obtain the coconut-based essence composition; partitioning the coconut-based essence composition into a plurality of vacuum sealable packages; and storing under a freezing temperature.

3. The method of claim 2, wherein the fibrous pulp is strained to obtain the coconut essence liquid during separation.

4. The method of claim 2, wherein the coconut-based essence composition comprises an amalgam comprising the pulverized coconut meat and testa, the coconut-based essence mixture, and residue of the interior and external surface of the coconut, wherein the amalgam comprises at least 1.3 oz of coconut shreds derived from the interior of the coconut.

5. The method of claim 2, wherein the method comprises thawing the coconut-based essence composition and whisking for a brief period to generate a creamy or milky texture of the composition.

6. The method of claim 5, wherein 750 cc of the coconut-based essence composition is applied to 1 lb. of rice.

7. The method of claim 2, wherein the coconut meat and the testa are extracted from the coconut by any one of puncturing, slicing, and splitting the coconut.

8. The method of claim 2, wherein the method comprises adding purified water or any other suitable liquid to the pulverized coconut meat and the testa and filtering to obtain the coconut-based essence liquid.

9. A coconut-based essence composition comprising about 140 grams of coconut cream concentrate, about 35 grams of sugar and about 11 grams of salt.

10. The coconut-based essence composition of claim 9, wherein the composition further comprises about 30 grams of testa.

11. The coconut-based essence composition of claim 9 is prepared by a method that comprises:
pulverizing coconut meat forming coconut cream concentrate to an average particle size of 0.001 microns, grinding the pulverized coconut meat to obtain a fibrous pulp containing a coconut essence liquid; separating the coconut essence liquid from the fibrous pulp; adding sugar and salt to the coconut essence liquid to obtain a coconut-based essence mixture; blending the coconut-based essence mixture for about 5 to 10 minutes to obtain the coconut-based essence composition; partitioning the blended coconut-based essence composition into a plurality of vacuum sealable packages; and storing under a freezing temperature.

12. The coconut-based essence composition of claim 11, wherein the fibrous pulp is strained to obtain the coconut essence liquid during separation.

13. The coconut-based essence composition of claim 11, wherein the coconut essence composition comprises an amalgam comprising the pulverized coconut meat and testa, the coconut-based essence mixture, and residue of the interior and external surface of the coconut, wherein the amalgam comprises at least 1.3 oz of coconut shreds derived from the interior of the coconut.

14. The coconut-based essence composition of claim 11, wherein the method comprises thawing the coconut-based essence composition and whisking for a brief period to generate a creamy or milky texture of the composition.

15. A coconut-based essence composition comprising about 140 grams of coconut cream concentrate and about 30 grams of testa.

16. The coconut-based essence composition of claim 15, wherein the composition further comprises about 35 grams of sugar and about 11 grams of salt.

17. The coconut-based essence composition of claim 15 is prepared by a method that comprises:
pulverizing coconut meat forming coconut cream concentrate and testa of coconut to an average particle size of 0,001 microns, grinding the pulverized coconut meat and testa to obtain a fibrous pulp containing a coconut essence liquid; separating the coconut essence liquid from the fibrous pulp and blending for about 5 to 10 minutes to obtain the coconut-based essence composition; partitioning the blended coconut-based essence composition into a plurality of vacuum sealable packages; and storing under a freezing temperature.

18. A coconut-based essence composition comprises about 140 grams of coconut cream concentrate.

19. The coconut-based essence composition of claim 18, wherein the composition further comprises about 30 grams of testa, about 35 grams of sugar and about 11 grams of salt.

20. The coconut-based essence composition of claim 18 is prepared by a method that comprises:
pulverizing coconut meat forming coconut cream concentrate to an average particle size of 0.001 microns, wherein testa is removed from the coconut meat, grinding the pulverized coconut meat to obtain a fibrous pulp containing a coconut essence liquid; separating the coconut essence liquid from the fibrous pulp and blending for about 5 to 10 minutes to obtain the coconut-based essence composition; partitioning the coconut-based essence composition into a plurality of vacuum sealable packages; and storing under a freezing temperature.
